(19) United States
(12) Patent Application Publication
(10) Pub. No.: US 2016/0364709 A1
(43) Pub. Date: Dec. 15, 2016

(54) UMBRELLA DISPENSATION KIOSK AND DISTRIBUTION SYSTEM

(71) Applicants: Anusha Kambhampaty, New York, NY (US); John Stewart O'Connor, New York, NY (US)

(72) Inventors: Anusha Kambhampaty, New York, NY (US); John Stewart O'Connor, New York, NY (US)

(21) Appl. No.: 14/738,644

(22) Filed: Jun. 12, 2015

(51) Int. Cl. G06Q 20/18; H04B 5/00; G06Q 20/32; G06Q 30/06; G06Q 20/40

(52) U.S. Cl. CPC G06Q 20/18; G06Q 30/0645; G06Q 20/401; G06Q 20/327; H04B 5/0062

(57) ABSTRACT

A a network of umbrella rental and return kiosks is described in which users may borrow a high quality umbrella and return it to a kiosk near their destination. The kiosks may be unattended and be configured to both dispense umbrellas and receive returns. Exemplary rental kiosks, in communication with a centralized server, may interface with users, coordinate dispensation, and manage payment. A network, exemplary kiosk, and methods for using the system and kiosk are disclosed.

### BACKGROUND

By some estimates, the umbrella finds its roots in ancient China, date to as early as 2,000 B.C. Four thousand years later, Americans spend nearly $400M on umbrellas each year, with many being lost.

The ubiquitous black street umbrella, readily available when rain is imminent, is known for its low cost and low quality craftsmanship, making it disposable in the eyes of many urban dwellers. These umbrellas are often used only once, and even when not initially discarded, break after only a few uses only to end up in a landfill.

Many people find carrying an umbrella to be burdensome and simply rely on the availability of these cheap disposable umbrellas in the event of rain. Indeed, one study found that 81% of New Yorkers consider carrying an umbrella to be a hassle.

By some estimates, the volume of umbrellas discarded worldwide each year would be sufficient to build 25 Eiffel Towers, an amount of waste that creates an environmental concern both in the consumption of raw materials and landfill space for disposal.

To avoid these cheap disposable umbrellas, some will resort to more durable models such as the Totes Titanium or Totes TRX. However, these umbrellas can exceed $50 making them painful to lose.

At the far end of the spectrum, some may consider an umbrella to be an important style accessory for which they will pay a premium. Umbrellas by Burberry can exceed $200 retail, and other brands can exceed $1,000.

Umbrella vending machines and kiosks have been proposed, but many of these machines rely on the same low-quality product that has been sold by street vendors for years. The problems of waste and lack of convenience persist.

Service providers may also loan umbrellas to their customers for short periods of time. For example, hotels, restaurants, and high-end retailers may all have umbrellas on hand for their guests. However, these guests often forget to return the umbrella, leaving the service provide to absorb the cost. Indeed, some guests may intentionally keep the umbrella as a souvenir of their experience, particularly if it is branded with the provider's logo.

There is thus a need for a system that reduces the waste generated by the one-time or limited use of umbrellas that are then discarded.

There is a further need for a system that provides convenient distribution of umbrellas where and when they are needed.

There is a further need for a system that provides the ability to loan umbrellas, whether for a fee or free, and tracks whether the umbrella has been returned.

### BRIEF DESCRIPTION OF THE DRAWINGS

The features and advantages of the present disclosure will be more fully understood with reference to the following detailed description when taken in conjunction with the accompanying figures, wherein:

FIG. 1 is a block diagram showing the various components of an embodiment of the invention.

FIG. 2 is a flowchart showing an exemplary method of use of the present invention.

FIG. 3 shows a block diagram of the various functional components of an exemplary rental kiosk according to embodiments of the present invention.

FIG. 4 shows a perspective view of a rental kiosk according to embodiments of the present invention.

FIG. 5 shows an exploded perspective view of a rental kiosk according to embodiments of the present invention.

FIG. 6 shows a partially-assembled perspective view of a rental kiosk according to embodiments of the present invention.

FIG. 7 shows a side view of an exemplary slide assembly according to embodiments of the present invention.

FIGS. 8A-8I show segments of an exemplary user interface according to embodiments of the present invention.

### SUMMARY

In some embodiments, an umbrella distribution system may include one or more distribution kiosks, and/or a central management server connected to the one or more distribution kiosks via a data link, and configured to receive and validate user account information from the one or more distribution kiosks via the data link. In some embodiments, the one or more distribution kiosks, may include a user interface, a network interface, a dispensation mechanism, and an umbrella cache.

In some embodiments, the one or more distribution kiosks are configured to, upon receiving validation from the central management server, direct the dispensation mechanism to dispense a unit from the umbrella cache.

In some embodiments, the one or more distribution kiosks are further configured to receive a return unit from a user. In some embodiments, the one or more distribution kiosks are further configured to receive payment information from a user. In some embodiments, payment information is received wirelessly by the one or more distribution kiosks.

In some embodiments, the user interface may include a wireless data link to a user's mobile computing device. In some embodiments, the umbrella cache is encoded with a tracking identifier. In some embodiments, the tracking identifier is stored using an RFID tag.

In some embodiments, a method of operating an umbrella distribution system may include providing one or more distribution kiosks; providing a central management server connected to the one or more distribution kiosks via a data link, and configured to receive and validate user account information from the one or more distribution kiosks via the data link; receiving and verifying the user account information on the central management server; and/or providing authentication to the one or more distribution kiosks over the data link to cause the one or more distribution kiosks to dispense a unit from the umbrella cache.

In some embodiments, such a method may further include receiving, from a user, the unit for return to the umbrella distribution system; authenticating the unit; and/or updating a user's account to reflect the return. In some embodiments, the authentication step may include reading an identifier on the unit. In some embodiments, the method may include the further step of wirelessly receiving payment data from a user's mobile computing device. In some embodiments, the step of reading an identifier on the unit may further include receiving RFID data from a RFID reader in communication with the one or more distribution kiosks.

In some embodiments, an umbrella rental kiosk may include a user interface; a network interface configured to provide data communication with a central management server; a slide assembly; a dispensation chute in communication with the slide assembly; and/or means for dispensing the umbrella from the slide assembly, through the dispensation chute to a user.

In some embodiments, the slide assembly may include a group of angled segments. In some embodiments, the slide assembly is configured to hold at least one umbrella.

In some embodiments, such a umbrella rental kiosk may further include a return means in communication with the slide assembly. In some embodiments, the slide assembly defines two or more storage channels. In some embodiments, a dispenser roller directs the at least one umbrella from the two or more storage channels to the dispensation chute. In some embodiments, such a umbrella rental kiosk may further include a group of sensors in communication with the central management server. In some embodiments, san umbrella rental kiosk may further include a climate control system for reducing the moisture level in the umbrella rental kiosk.

### DETAILED DESCRIPTION

In embodiments, a network of umbrella rental and return kiosks is described in which users may borrow a high quality umbrella and return it to a kiosk near their destination. The kiosks may be unattended and be configured to both dispenses umbrellas and receive returns.

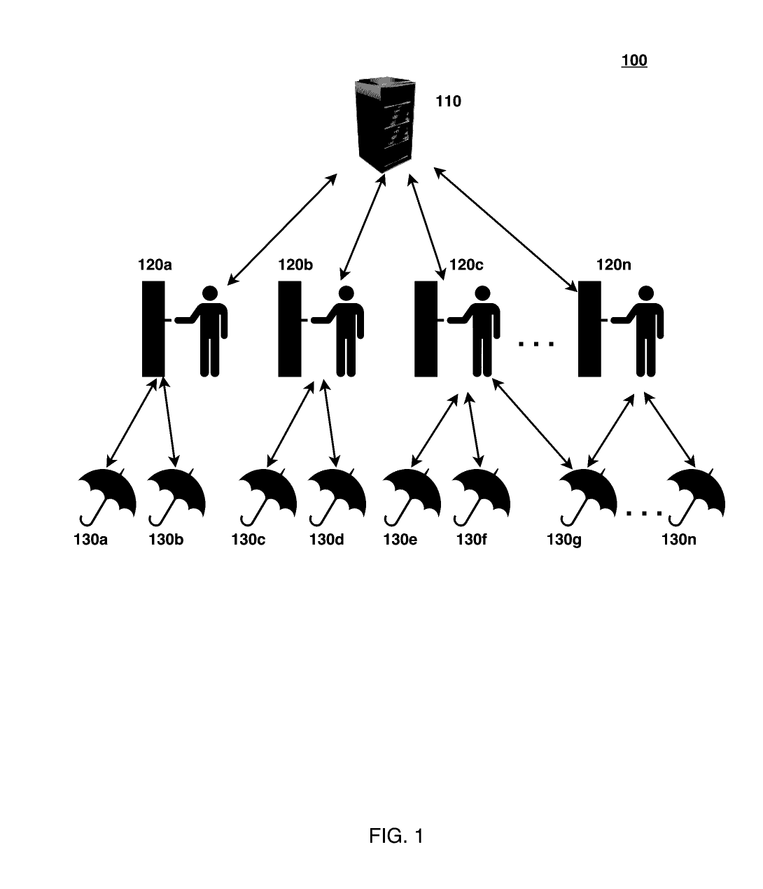

Referring to FIG. 1, a diagram of an exemplary network of umbrella rental kiosks is shown. A centralized server 110 communicates with one or more umbrella rental kiosks 120a-120n that in turn manage the rental and return of a plurality of umbrellas 130a-130n. As shown, in embodiments, a particular umbrella may be associated with a single rental kiosk or may be rented from one kiosk and returned to a different kiosk. Each of these components and their relative functions will be discussed in detail below.

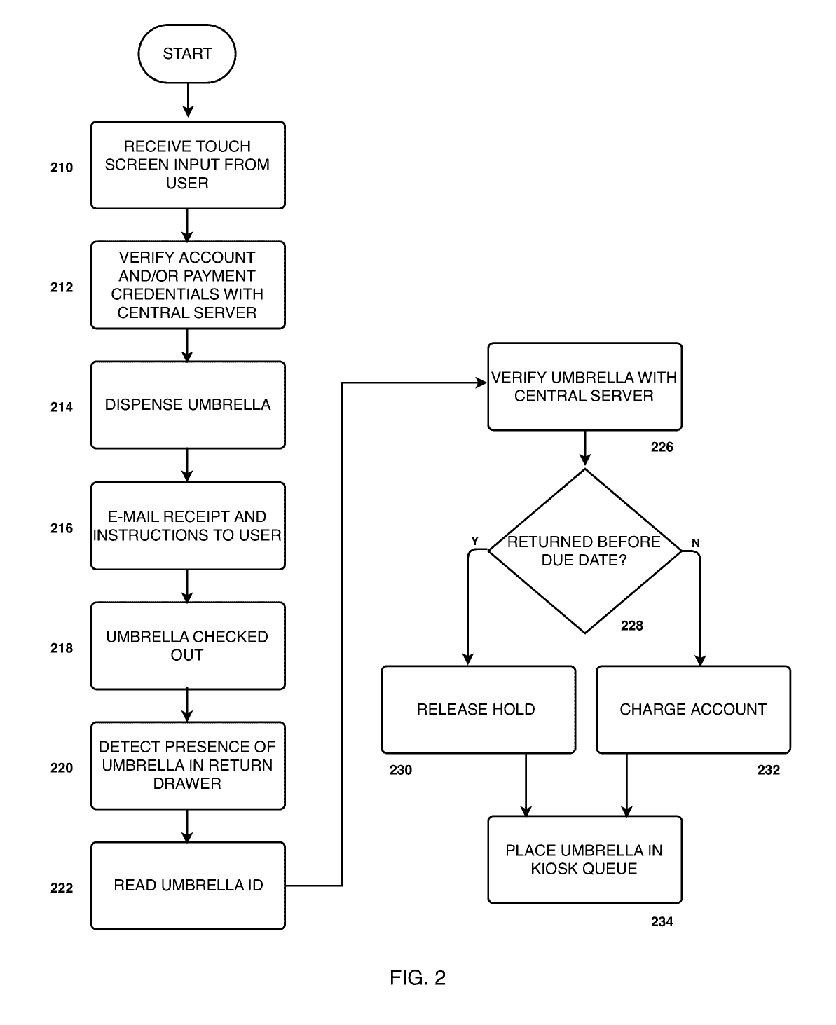

Referring to FIG. 2, an exemplary method of operation of the system of the present invention is shown.

An idle rental kiosk may first determine whether a user has entered input on a touch screen of the rental kiosk (step 210). If the user has indicated that he/she would like to rent an umbrella, kiosk may receive identification and payment information from the user. Identification and payment information may be in the form of a login to a pre-verified account, or a new account that is paired with a payment method. Kiosk may then verify the identification and/or payment credentials with a central server (step 212) that may be configured to manage all users accounts and payment information. Having received verification from the server, kiosk may then dispense an umbrella to the user (step 214).

An e-mail, text message, printed receipt, or other communication may then be sent to the user (step 216) specifying the return time, and providing any other information that may be relevant to the rental experience. For example, a user may be provided with the upcoming weather forecast or the location of return kiosks near their destination.

The return process (step 220) is commenced by detecting the presence of an umbrella in the return slot drawer. In embodiments, a user may initiate the return process using the touchscreen or other input device.

The system may then proceed to verify (step 222) that the object is the umbrella that was checked out previously by the user. As discussed below, verification can be made by a unique indicator, by the physical characteristics of the object returned, or by other methods. The kiosk may then confirm with the central server (step 226) that the umbrella is eligible for return (e.g., the user previously checked out an umbrella).

If the umbrella has been returned on time, any payment holds placed on the user's account (step 230) may be released. If the umbrella is late, a late fee may be applied (step 232). In embodiments, the system may charge the user's account for the late umbrella prior to the initiation of the return sequence and may make a determination to charge the user for the full cost of the umbrella once a pre-set time window has passed.

In either case—timely return or late return—the umbrella is received by the kiosk an placed in the queue (step 234) for future rental.

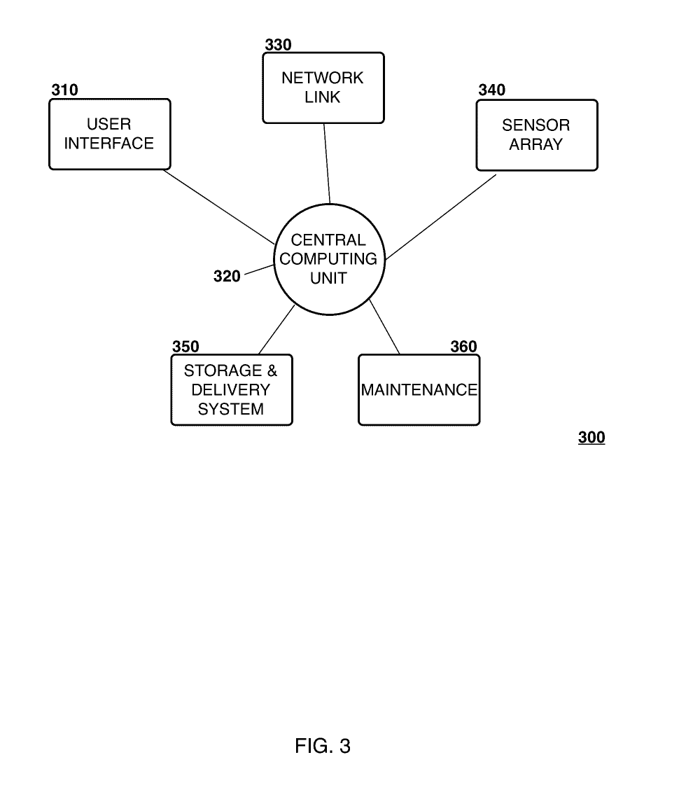

Referring to FIG. 3, a block diagram of the various functional components of a rental kiosk 300 are shown. Rental kiosk 300 may generally be subdivided into the following functional areas: (1) user interface; (2) network link; (3) sensor array; (4) maintenance/diagnostics; (5) conveyor system; and (6) central computing unit. The components comprising these functional blocks may be housed in a unified physical enclosure.

In embodiments, a user interface 310 may be provided. In a preferred embodiment, user interface 310 may be an industrial grade four-wire touchscreen that is configured to provide rental and return options to the user. User interface 310 is, preferably, weather resistant and capable of withstanding heavy usage in a variety of environments. In embodiments, user interface 310 may be fitted with a protective screen that resists damages, weather, vandalism and prolongs the life of the user interface.

In alternate embodiments, kiosk 300 may omit a screen-style user interface and instead interact with a user's mobile computing device (smartphone, tablet, etc.), using the display of the smartphone as the primary point of interaction with the machine. Users may be able to pair the smartphone with kiosk 300 via Bluetooth, Bluetooth Low Energy, or other wireless technologies such as NFC, Wi-Fi, and so forth. Kiosk 300 may optionally be fitted with a reader that is capable of scanning a bar code, QR code, or indicator on the screen of the user's device indicating that a rental has been authorized or verifying the identity of the user.

In embodiments of the invention, kiosk 300 may have a central computing unit (“CCU”) 320 that acts as the “brains” of the kiosk. CCU 320 may control the user interface, providing options to the user and receiving information from the user that, and managing the user's interaction with the system. CCU 320 may request authorization to release an umbrella from a central server, or may provide information back to a central server that an umbrella has been returned. CCU 320 may control and operate the dispensation hardware, provide diagnostics and servicing information back to the central server, coordinate sensor functions, monitor system load and supply, and any other functions that require control, direction, or monitoring of components in the kiosk.

In embodiments, CCU 320 is any general or special purpose computer capable of managing the user interface, controlling communications with the centralized server, and managing all hardware components and sensors. In exemplary embodiments, CCU may be a personal computer running a personal computer operating system, or may be a custom hardware design. In alternate embodiments, kiosk 300 may omit a CCU and instead be under the direct control of a centralized server. In such a configuration, kiosk 300 may operate as a dumb terminal in which all functionality is controlled from a centralized server that is connected to kiosk 300 via a communications link.

A network link 330 may be provided for connecting the kiosk to the centralized server for transmitting payment information, verifying user accounts, communicating usage and maintenance information, and the like. In a preferred embodiment, network link may be wireless and use the Wi-Fi or 4G protocols. In alternate embodiments, conventional Ethernet, RJ-45, fiber optic, or other wired connections may be utilized.

In embodiments, a storage and delivery system 350 is employed for moving umbrellas within the device to, for example, dispense an umbrella to a waiting user, or receive a returned umbrellas from a user. Various conveyor systems are contemplated as coming within the scope of the invention and may include, for example, a passive network of angled slides that rely on gravity, motorized conveyor belts, individual drawers that are moved by a belt and motor, and the like.

To confirm correct operation, secure the device, track inventory, and other features, kiosk 300 may utilize an array of sensors 340. In embodiments, electromagnetic or optical sensors may be utilized to monitor the flow of umbrellas within the kiosk, and verify the level of inventory and determine if a jam or other malfunction has occurred. In alternate embodiments, weight-based sensors may be utilized to track inventory verify that the article returned by the user is the correct product.

In embodiments, RFID tags may be use to track inventory and verify that the article returned by the user is the correct product. In embodiments, each umbrella may be tagged with an RFID tag that provides an identification number unique to the umbrella, the kiosk, or the rental network, and identifies the umbrella to the machine. In embodiments, a corresponding RFID reader may be installed in the kiosk.

In embodiments, kiosk may comprise a GPS sensor for security and loss prevention purposes. For example, a kiosk may be programmed to operate only at a specific location, which location can be verified by using a GPS sensor to calculate the specific location. In embodiments, kiosk could be programmed to go into a “security mode” if it is moved from its programmed location. “Security mode” could include shutting down normal functioning, locking the device, sounding an alarm, or transmitting a location beacon. In embodiments, kiosk may include a motion sensor and/or gyroscope to determine if it has been moved or tipped over.

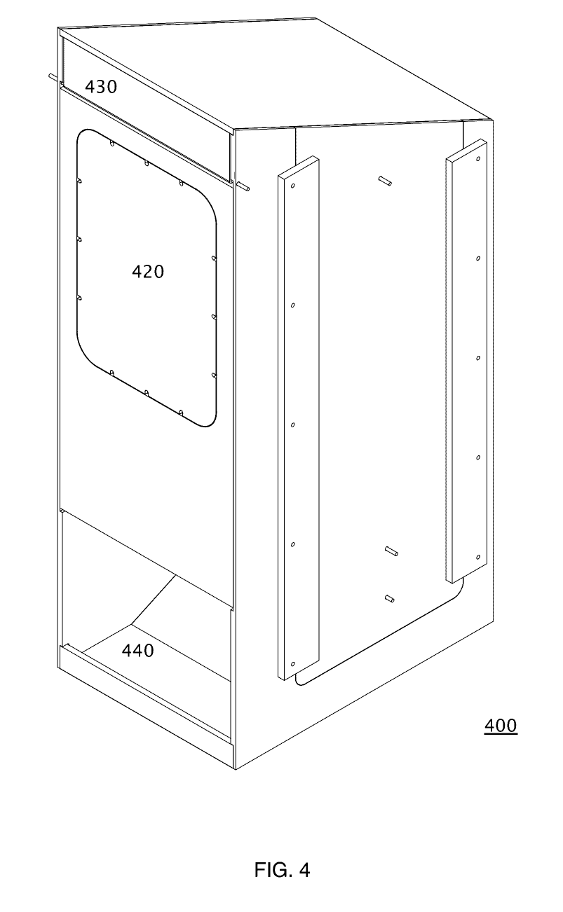

Referring to FIG. 4, an embodiment of a rental kiosk 400 is shown.

In a preferred embodiment, kiosk 400 may be roughly 17.5″ in width, 40 inches high, and 16 inches deep with capacity for 48 umbrellas. The foregoing size and capacity has been found to meet a balance between minimizing the footprint of the device while having sufficient capacity for umbrellas for a typical location. Myriad other configurations may be utilized and may depend on the type of location (e.g., whether retail where floor space is at a premium or a college campus where space may be more available), the anticipated usage and foot traffic near the location, security issues, and other considerations.

In embodiments, kiosk 400 may comprise an exterior enclosure formed from material that is, preferably, high quality, corrosion-resistant, and durable. Examples include stainless steel, carbon steel, aluminum, plastic, and the like. For durability purposes or aesthetics, additional coating may be applied to the exterior enclosure such as powder coating, plating, painting, or galvanization. In embodiments, exterior enclosure of kiosk 400 may be branded with a company or organization logo or trade dress.

A touchscreen 420 is fitted on a front side of the device where it can be engaged by the user. Touchscreen 420 may be fitted behind protective shield that prevents the screen from damage or vandalism.

A return slot 430 may be position at the top of the front of the device and comprise a recess for receiving an umbrella, and be protected form the outside by a protective door. In embodiments, return slot 430 is connected to an internal queue of umbrellas for rental and/or sale. When the system accepts an umbrella through return slot 430, it may be placed in this queue for future dispensing.

A locking mechanism may be provided to secure to return slot 430 until a user has begun the return process by engaging touchscreen 420 or presenting an umbrella for return. Such a locking mechanism ay secure the machine and deter vandalism.

In embodiments, return slot 430 may contain the sensors referenced above for detecting the presence of an authentic umbrella for return and reading any identifying information.

In alternate embodiments, return slot 430 may feed be in the form of a drawer that receives an umbrella for return. A return draw may be further configured to rotate 180 degrees to deposit the umbrella into a return queue before returning to the original position.

In embodiments, a dispensing chute 440 may be provided for delivering an umbrella from the internal queue to the user. In embodiments, dispensing chute 440 may be a gravity-fed slide that receives a single umbrella and form the queue and delivers it to the user.

An exemplary kiosk may have additional features not shown in FIG. 4. For example, kiosk 400 may have a ventilation system that circulates air through the kiosk and promotes drying. Since umbrellas may be returned while still wet, the umbrella stock as well as various system components may get wet and water may collect in certain areas. A ventilation system comprising a plurality of vents and, optionally, one or more fans will encourage drying and extend the life of the machine and the umbrellas.

In embodiments, a drip tray may be provided to remove excess water after high traffic. Drip tray maybe fitted to the underside of the machine where water can collect under force of gravity. The tray may then be removed by on-site personnel.

In embodiments, kiosk may be fitted with wheels or a “tilt and roll” wheel set that allows the unit to be easily moved. In a preferred embodiment, wheels may be lockable to discourage theft or vandalism.

In a preferred embodiment, a single configuration of kiosk may be utilized, or a limited number thereof, to reduce manufacturing and servicing costs and present a unified and consistent appearance to the user. In alternate embodiments, a variety of configurations of kiosk may be used within a single system to, for example, target particular user segments, better accommodate various locations for the kiosks, account for stylistic or branding concerns in various regions, address security or weather concerns, and the like.

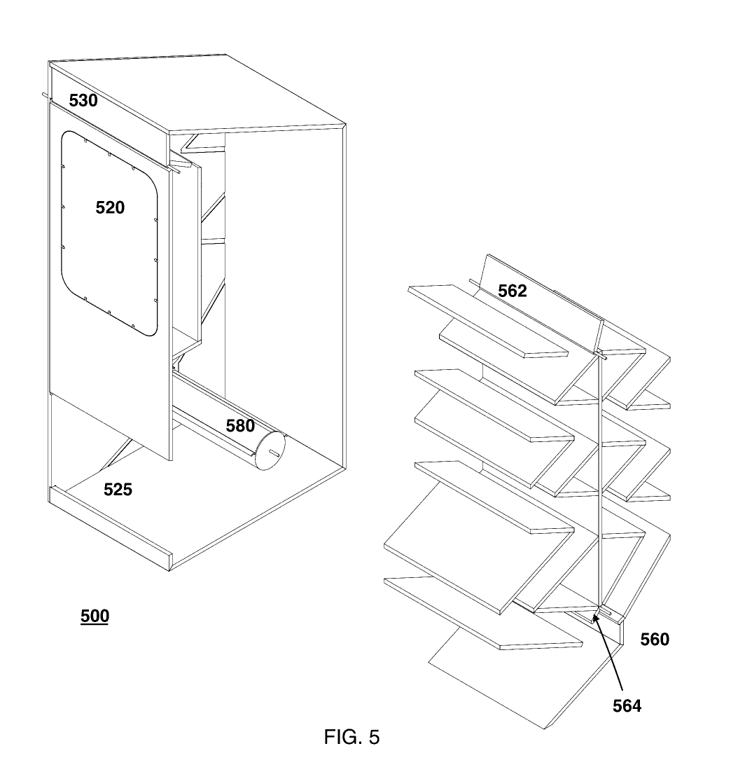

Referring to FIG. 5, an exploded perspective view of an exemplary kiosk 500 is shown. As with FIG. 4, a screen 520 and return slot 530 may be seen. Dispensing chute is formed from an opening in the face 525 of kiosk 500, and a portion of slide assembly 560.

In use, slide assembly 560 will be fitted into the enclosure.

In embodiments, slide assembly 560 comprises a plurality of angled segments defining one or more pathways that connect the return and intake slots with the dispensation chute. Top and bottom diverter doors 562, 564 may also be provided for managing the flow of umbrellas from the storage channels. The specific configuration of the pathways, slots, and doors may depend on the size and capacity of the machine, anticipated usage, servicing frequency, and other factors.

A dispenser roller 580 may be provided and be rotatably connected to a motor. with motor 580 being position adjacent the base of slide assembly 560. Dispenser roller 580 is configured to manage the multiple storage channels converging at the base of the kiosk adjacent the dispensing chute. In embodiments, dispenser roller may be hollow and partially open, or may be subdivided into multiple segments. Dispenser roller may be configured as a “bucket” that receives an umbrella from one of the storage chutes and delivers it to the dispensation chute as the roller is rotated.

FIG. 6 shows the slide channel positioned in the main portion of the kiosk 600 for use.

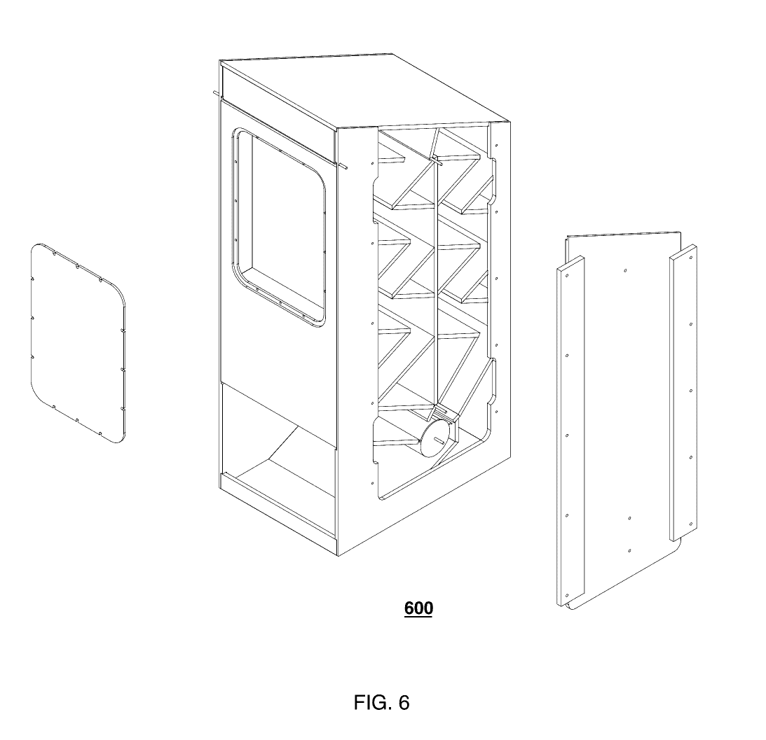

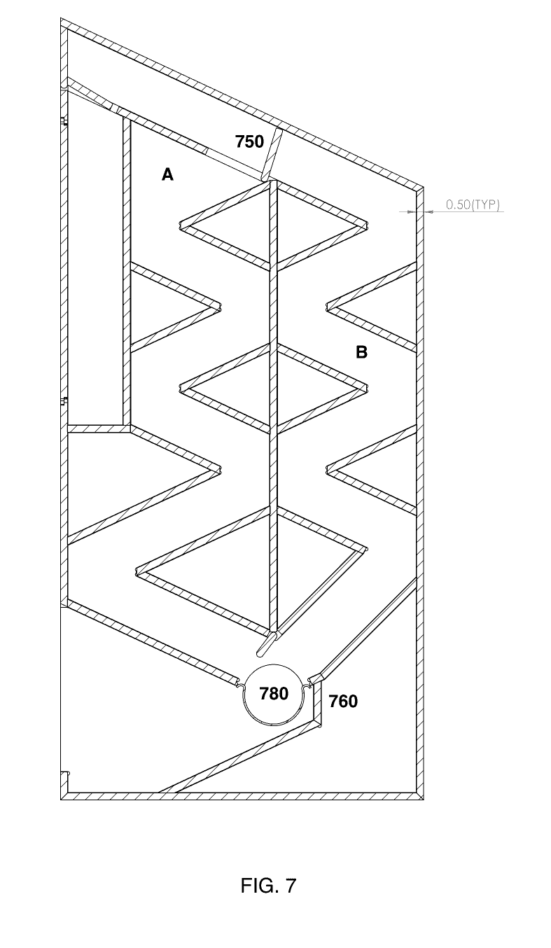

A side view of a slide assembly is shown in FIG. 7.

In embodiments, angled segments may be made from any material that has a low coefficient of friction relative to the outer surface of the umbrella. In a preferred embodiment, polished stainless steel may be used.

In a preferred embodiment, and referring to FIG. 7, a series of angled segments defines two storage pathways, namely an A storage channel and a B storage channel. Each storage pathway extends independently from top to bottom in a zigzag manner before converging on dispenser roller 780. A top diverter door 750 may be provided for directing incoming umbrellas—i.e., those being returned by users—into either storage pathways. The choice of storage pathway will depend on the utilization level of each channel. If the A storage channel is full (or nearing capacity) and cannot take in any further umbrellas, top diverter door 750 will be placed in the down position so that incoming umbrellas are directed to the B storage channel. If the B storage channel is full (or nearing capacity) top diverter door will be placed in the up position (as shown) so that incoming umbrellas are directed to the A storage channel.

A bottom diverter door 760 may also be provided for controlling which storage channel is fed into dispenser roller 780. As with the top diverter door, the choice of position for the bottom diverter door will depend on the capacities of the channels, operator preference, or other factors.

Diverter doors 750, 760 are preferably linked together with a belt so a single motor may simultaneously control movement of both doors.

In embodiments, a dispenser roller 780 is a cylinder that is partially open along its length. In a preferred embodiment, dispenser roller 780 may be large enough in diameter for a single umbrella to fit therein, a may be open enough for a single umbrella to pass to the interior. In embodiments, the opening (measured as the chord distance from side so side of the cross section) will be roughly the same as the width of the storage channels.

Alignment cams may be provided on dispenser roller to align the roller with the storage channels and reduce then chances of a jam.

In exemplary embodiments, an umbrella inserted into return slot 730 will proceed under force of gravity through the A storage channel until it either encounters: (1) the back end of a column of umbrellas stored in the storage channel; (2) the dispensation roller; or (3) the bottom diverter door.

Similarly, fresh umbrellas deposited by an operator through a lot (not shown) at the top of B storage channel will fall through the slide segments. Because the slide segments are angled and because the umbrellas are substantially round in cross section when closed, the machine can be fed with only a single motor at the base. Further, as more umbrellas are deposited into each storage pathway, the weight of the recently-added umbrellas may exert downward pressure on the stack causing the umbrellas to exit at the base.

Umbrella stock may be held in the storage pathways by a dispensing roller 780 that blocks the base of each respective storage pathway until the dispensing wheel is rotated.

In embodiments, the kiosk is able to recognize error conditions and make requests for servicing or maintenance.

For example, if a sensor adjacent the dispensing roller shows that the dispensing roller is empty, while the adjacent storage channel shows as full of umbrellas, a jam is likely and maintenance may be summoned.

Alternatively, if no umbrellas are returned before the dispensing stack empties (i.e., the sensors in both the A and B storage channels are showing the channel is empty), CCU will be notified and remedial action taken. For example, CCU could turn on an indicator light stating that the machine is unable to dispense umbrellas (though returns could be accepted). Similarly, if all storage channels are full, the kiosk cannot accept returns and the CCU would indicate by indicator light or message on the touchscreen that it is out of service for returns. Sensors indicating a tilt condition may indicate a more immediate concern for the machine, which may be communicated to the CCU.

In either case, an alert would be sent to a centralized server so that a serviceman could be sent to either empty one stack or fill one stack depending on the error.

The process of a user engaging the system to obtain or return an umbrella using the embodiments shown in FIGS. 4-7 will now be described.

In operation, when the system determines that an umbrella should be dispensed, CCU directs dispensing roller to turn, depositing the umbrella in the dispensing roller into the dispensing chute, and allowing a new umbrella to enter the dispensing roller at the end of the degree turn.

For a return, an opposite process may be utilized. After engaging the system and indicating that an umbrella is being returned, the user may place the umbrella in the return drawer or slot. If only a gravity-fed slot and storage channel are employed, there is no further action to take with respect to moving the umbrella into the storage channel beyond verification. If a motorized return drawer were employed, CCU would direct the relevant motor to turn the return drawer to deposit the returned umbrella into the machine, and on the top of the stack at the end of the queue.

In embodiments, kiosk may be initially configured with the A channel empty, and the B channel full of umbrellas. As users return umbrellas, the upper diverter door will be in the up position so the umbrellas will be diverted down the front stack. As users take umbrellas, they will be delivered from the B storage channel. This arrangement will create a receive-to-return buffer equal to the capacity of the stack.

If a sensor at the bottom of the B storage channel indicates that the rear stack is empty, the upper diverter door will switch to the down position. As the upper and lower diverter doors are linked, the lower diverter door will alternate to feed from the opposite storage channel.

When both doors switch, incoming returned umbrellas will enter the B storage channel, and dispensing umbrellas will be fed from the A storage channel, which has been filling with umbrellas as users make returns.

In embodiments, a return may be accepted without the user first engaging the system. For example, kiosk may be configured to sense—by weight, infrared sensors, or other known technology—the presence of an umbrella in the return drawer. The system may then proceed to identify the umbrella using an embedded RFID tag, bar code or otherwise.

For an umbrella purchase a separate motor may be engaged so that the user is given a brand new (or refurbished) umbrella as opposed to one that has recently been returned. In alternate embodiments, a purchase system may use the same motor and same umbrella stock as is used for rentals. Such a construct would simplify the machine—and reduce its cost—since fewer motors could be employed and fewer channels for umbrella delivery would be required.

In embodiments, various software is employed—both in the kiosk and on a central server—for controlling the operation of the physical components of the system, interacting with the user, performing financial transactions, verifying the security and integrity of the system, coordinating intra-system communication, and other functions.

The specific details of the software installed in the kiosk will vary depending on the user base, specific application, marketing considerations, system topography, and other considerations.

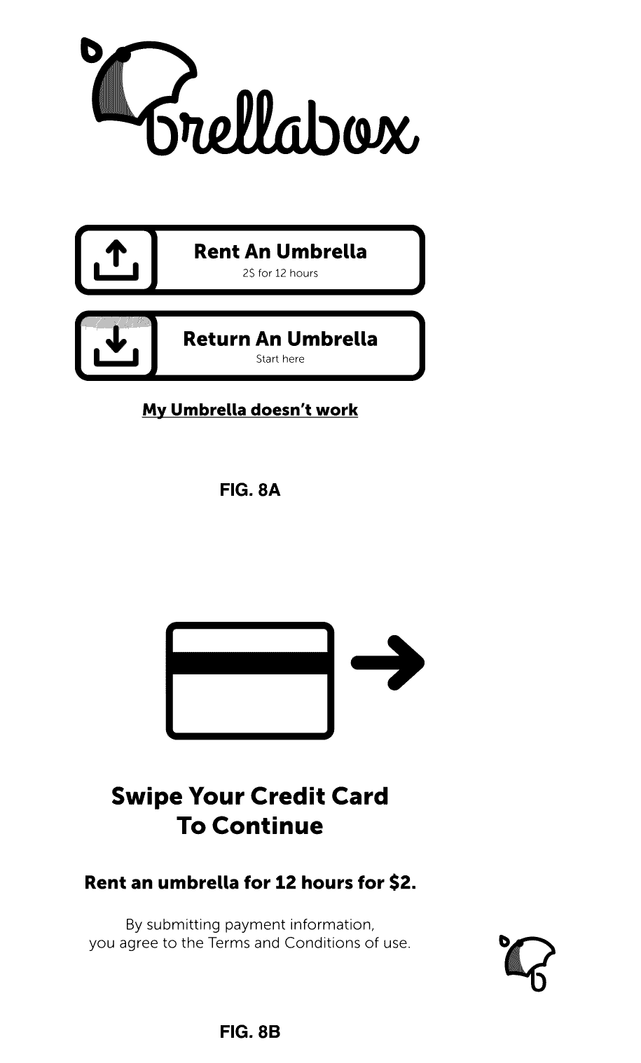

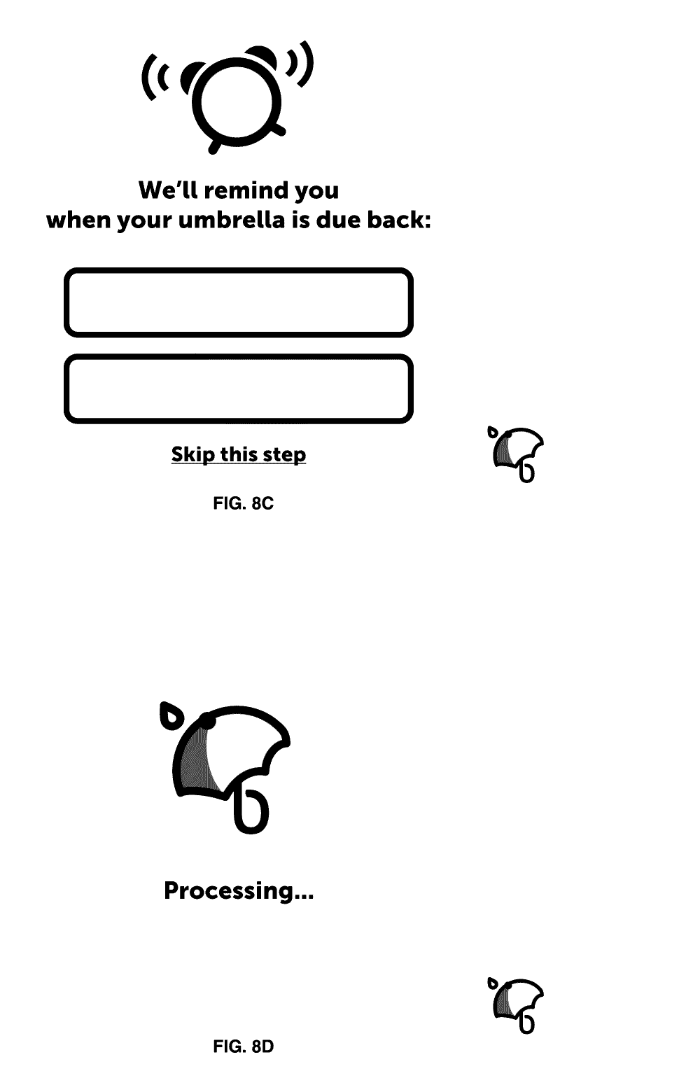

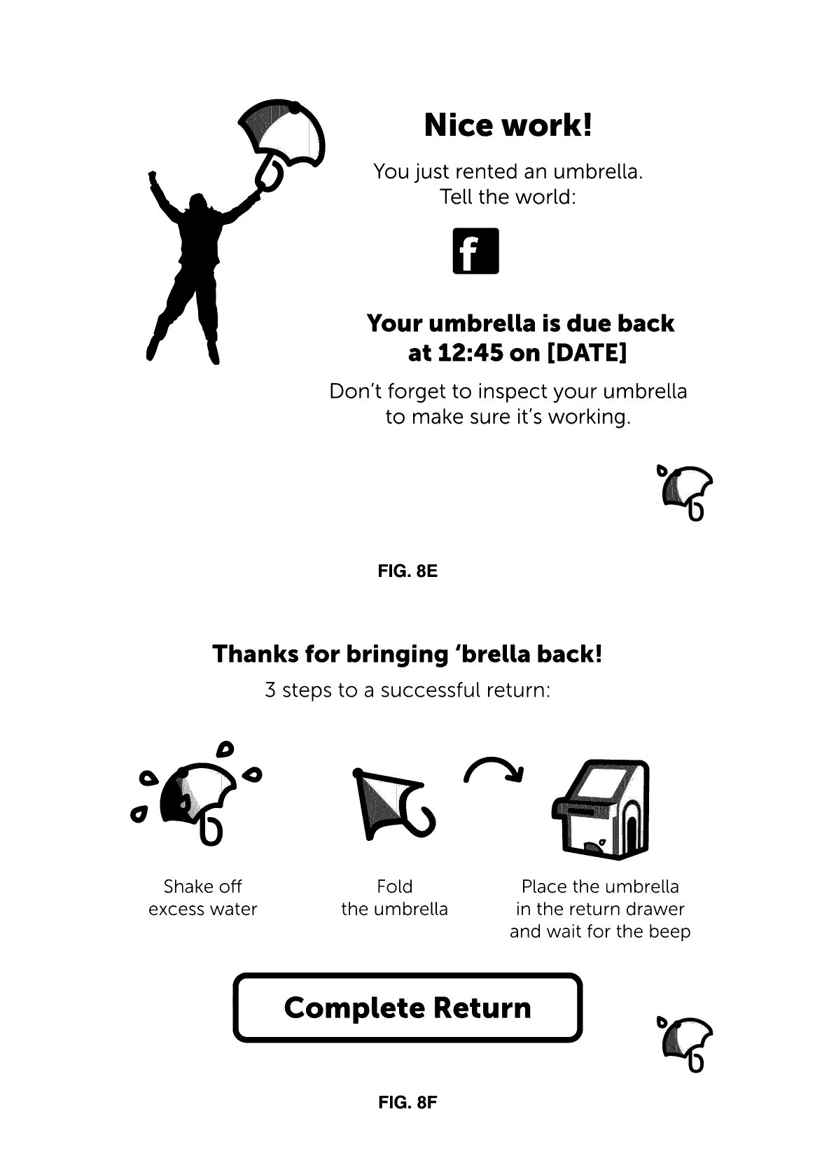

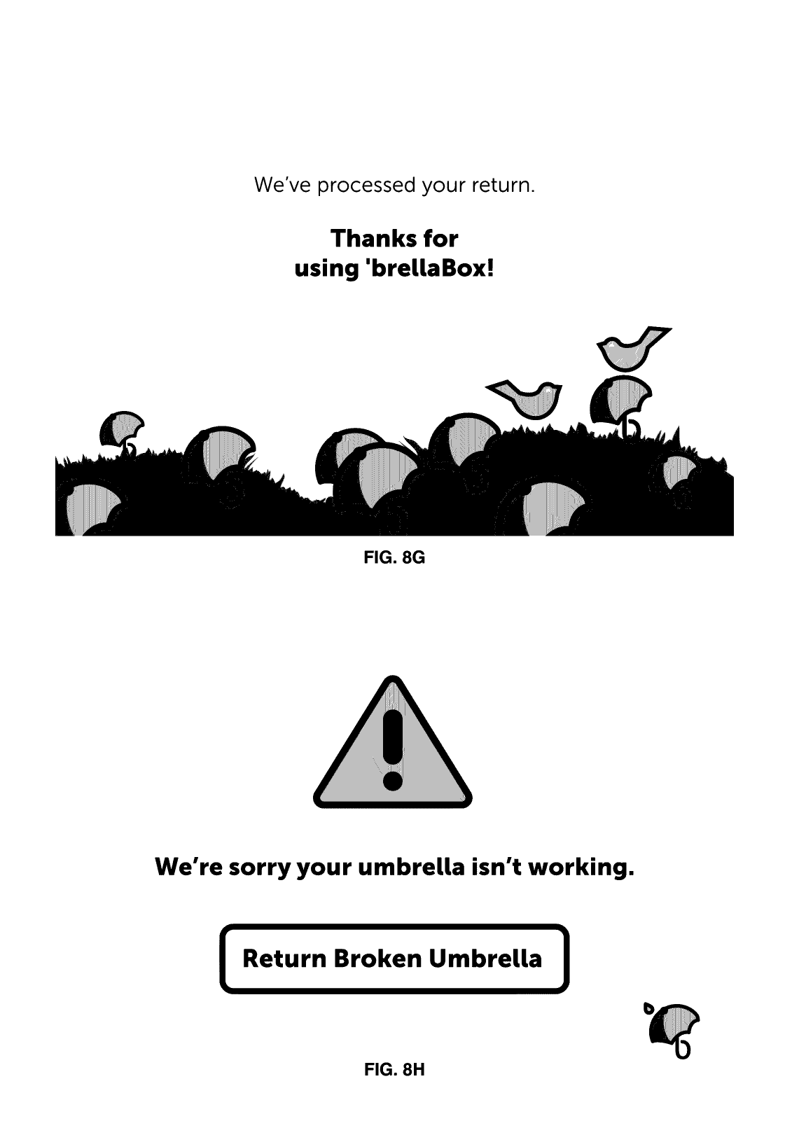

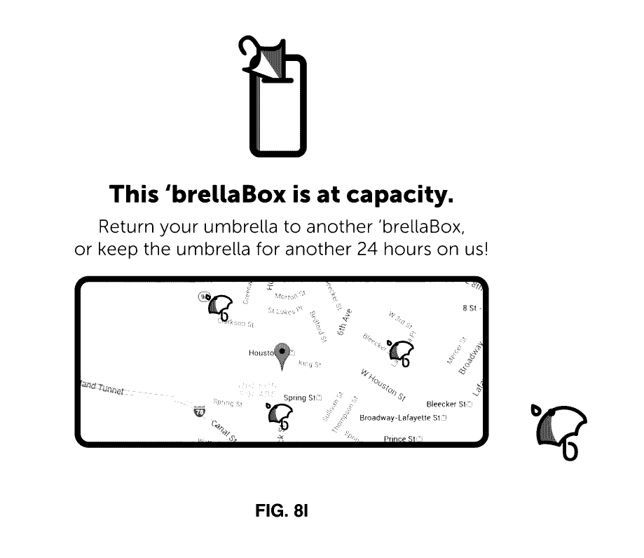

A sample user interface design is shown in FIGS. 8A-8I. Referring to FIG. 8A, a sample user welcome screen is shown, which may be branded with the logo of the host location, advertising, or other information. A user may be presented with two main options—renting an umbrella and returning an umbrella—and a separate option if an umbrella rented from the system is malfunctioning.

Having selected the rental option, a user may then be presented with a payment page (FIG. 8B). Payment page may request that a credit card be swiped through the credit card reader, or that payment be confirmed by other methods such as Apple Pay, PayPal, Google Wallet, NFC, or the like. A user may be given the option (FIG. 8C) to enter their contact information so that a reminder will be sent when the umbrella is due back.

After processing (FIG. 8D), the user may be presented with a completion page (FIG. 8E) with information about the return date, and options for posting their umbrella activity on social media sites such as Facebook and Twitter.

When the user returns the umbrella, and has selected “Return An Umbrella” from the welcome screen, they will be directed to the return screen shown in FIG. 8F. Instructions may be given to the user for the return process such as shaking off excess water, ensuring that the umbrella is securely folder, and depositing the umbrella in the return drawer. Once the umbrella has been verified, the user may be presented with the closing screen shown in FIG. 8G.

In the event of a broken or malfunctioning umbrella, the user may be given options for return (FIG. 8H).

Where the kiosk is at capacity and cannot accept any more umbrellas for return, a warning screen (FIG. 8H) may be given to the user, along with a map showing alternate locations where a return can be made. A corresponding screen may be shown where the machine is empty and a user is directed to alternate kiosk locations that are stocked with umbrellas.

In addition to user interface functions, software in the kiosk, and on the centralized server, may provide a variety of additional functions.

In embodiments, software will enable the kiosk to communicate with payment processing APIs—either directly or through centralized server—such as Braintree, and enable a secure transaction. In embodiments, kiosk may be able to process credit and debit cards through an attached credit card reader. In embodiments, server may be configured to store all payment transactions, membership information and use the traffic to send the code or tag ID with that of customer information and then apply payments.

In embodiments, software running on the kiosk or server may be able to read and process information encoded on the umbrella stock, via a physical sensor, in a variety of formats such as Bluetooth, RFID, bar codes, QR codes, and the like.

In embodiments, user interface may be configured to present different rental/purchase/lease options depending on individual user characteristics, time of day, system load, weather forecast, or other factors calculated by the system.

In embodiments, system software may control the actuation of the stepper motor used in the delivery roller.

In alternate embodiments, the system of the present invention may be used to dispense and receive articles other than umbrellas.

Several usage scenarios will now be described.

In one example, it is 6 p.m. on Jun. 5, 2014 and Helen, an entrepreneur, does not have an umbrella and there is a torrential summer rainfall. A branded kiosk has been installed in Helen's co-working space as a benefit for tenants.

Helen approaches the machine and is met with a touch screen menu that gives two options: (1) rent an umbrella (free of charge for 16 hours) or (2) purchase an umbrella for $15. Helen selects the rental option, enters her email address and swipes a credit or debit card.

Helen's card is approved, and an umbrella dispenses at the feeder area at the bottom of the machine. The screen says “Please take your umbrella, we will email you instructions for use and return. Thank you for using “Coworking ‘brellaBox!”

A hold of $15 is made on her credit card. She is sent a receipt via email regarding the hold made on her credit card, along with instructions for using the system. Helen is advised in the e-mail that if the umbrella is not returned by 10 a.m. on June 6th, she will be charged the full $15.

At this point, the kiosk begins the process of physically dispensing the umbrella. A dispensation motor is activated, which rotates a dispensation roller approximately three quarters of a turn (270 degrees counterclockwise) to push the umbrella on at the bottom of the stack (top of the queue) out of the maze.

The umbrella falls into the dispenser where it is retrieved by Helen.

Returning to work the following day at 9 a.m., Helen returns the umbrella by depositing the umbrella in the top feeder of the kiosk.

Recognizing that an umbrella has been placed in the return area, the system engages commences the physical return process. A return motor is activated, which and rotates the return drawer a full turn (360 degrees) clockwise to drop the returned umbrella on top of the stack at the end of the queue. An RFID tag embedded in the umbrella is read to confirm that the correct umbrella has been returned. Having verified the RFID tag and confirmed that the physical umbrella has been deposited in the machine, the kiosk updates the status of Helen's umbrella as returned.

Helen is not charged $15 and the hold on her credit card is lifted.

Consider an alternate scenario in which Helen does not return the umbrella within 16 hours. At 10:01 AM on June 6th, Helen's card would automatically be charged $15. If Helen had attempted to return the umbrella, the system would still have accepted it, but would have applied a late charge to Helen's account.

It will be understood that there are numerous modifications of the illustrated embodiments described above which will be readily apparent to one skilled in the art, such modifying the kiosk configuration, modifying the user interface, alterations to the rental terms, and any other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. An umbrella distribution system comprising:
one or more distribution kiosks, each comprising a user interface, a network interface, a dispensation mechanism, and an umbrella cache;
a central management server connected to said one or more distribution kiosks via a data link, and configured to receive and validate user account information from said one or more distribution kiosks via said data link;
wherein said one or more distribution kiosks are configured to, upon receiving validation from said central management server, direct said dispensation mechanism to dispense a unit from said umbrella cache.

2. The umbrella distribution system of claim 1 in which said one or more distribution kiosks are further configured to receive a return unit from a user.

3. The umbrella distribution system of claim 1 in which said one or more distribution kiosks are further configured to receive payment information from a user.

4. The umbrella distribution system of claim 3 in which said payment information is received wirelessly by said one or more distribution kiosks.

5. The umbrella distribution system of claim 1 in which said user interface comprises a wireless data link to a user's mobile computing device.

6. The umbrella distribution system of claim 1 in which said unit from said umbrella cache is encoded with a tracking identifier.

7. The umbrella distribution system of claim 6 in which said tracking identifier is stored using an RFID tag.

8. A method of operating an umbrella distribution system comprising the steps of:
providing one or more distribution kiosks, each comprising a user interface, a network interface, a dispensation mechanism, and an umbrella cache;
providing a central management server connected to said one or more distribution kiosks via a data link, and configured to receive and validate user account information from said one or more distribution kiosks via said data link;
receiving and verifying said user account information on said central management server; and
providing authentication to said one or more distribution kiosks over said data link to cause said one or more distribution kiosks to dispense a unit from said umbrella cache.

9. The method of claim 8 further comprising the steps of:
receiving, from a user, said unit for return to said umbrella distribution system;
authenticating said unit; and
updating a user's account to reflect the return.

10. The method of claim 9 further wherein said authentication step comprises the step of reading an identifier on said unit.

11. The method of claim 8 comprising the further step of wirelessly receiving payment data from a user's mobile computing device.

12. The method of claim 10 wherein said step of reading an identifier on said unit further comprises receiving RFID data from a RFID reader in communication with said one or more distribution kiosks.

13. An umbrella rental kiosk comprising:
a user interface;
a network interface configured to provide data communication with a central management server;
a slide assembly comprising a plurality of angled segments, wherein said slide assembly is configured to hold at least one umbrella;
a dispensation chute in communication with said slide assembly; and
means for dispensing said umbrella from said slide assembly, through said dispensation chute to a user.

14. The umbrella rental kiosk of claim 13 further comprising a return means in communication with said slide assembly.

15. The umbrella rental kiosk of claim 13 wherein said slide assembly defines two or more storage channels.

16. The umbrella rental kiosk of claim 15 further wherein a dispenser roller directs said at least one umbrella from said two or more storage channels to said dispensation chute.

17. The umbrella rental kiosk of claim 13 further comprising a plurality of sensors in communication with said central management server.

18. The umbrella rental kiosk of claim 13 further comprising a climate control system for reducing the moisture level in said umbrella rental kiosk.
